(19) United States
(12) Patent Application Publication
(10) Pub. No.: US 2025/0162678 A1
(43) Pub. Date: May 22, 2025

(54) CRANK POWER MEASUREMENT SYSTEM

(71) Applicant: YU-YU CHEN, New Taipei City (TW)

(72) Inventor: YU-YU CHEN, New Taipei City (TW)

(21) Appl. No.: 18/916,690

(22) Filed: Oct. 15, 2024

(30) Foreign Application Priority Data
Nov. 21, 2023 (TW) 112212738

(51) Int. Cl. B62J 45/421; B62J 45/411

(52) U.S. Cl. CPC B62J 45/421; B62J 45/411

(57) ABSTRACT

The present invention relates to a crank power measurement system, in which a hollow area is formed in the crank, and a hollow area top wall, a hollow area bottom wall corresponding to the hollow area top wall, and corresponding hollow area inner walls are formed in the hollow area. At least one first strain gauge is located on the hollow area top wall; and at least one second strain gauge is located on the hollow area bottom wall. According to the present invention, the effective power applied by the user to the crank can be accurately and efficiently measured, thereby meeting high-quality requirements, saving material costs, and better meeting environmental and green energy requirements.

### BACKGROUND OF THE INVENTION

### Fields of the Invention

The present invention relates to a force measurement device and, more particularly, to a crank power measurement system, for sensing the deformation and/or torsional deformation of a crank.

### Descriptions of Related Art

The traditional technique for measuring the power output of a cyclist while pedaling by bicycle cranks has been found in, for example, U.S. Pat. No. 9,417,144. In the patent, an externally attached module is affixed to the inner side of the crank and configured with a strain gauge therein. The strain gauge senses the deformation of the crank, allowing for the calculation of the force applied to the crank. Similarly, in U.S. Pat. No. 11,033,217, strain gauges arranged in different orientations are positioned on the inner side of the crank to detect both deformation and torsional deformation of the crank.

However, in practical applications, the conventional force measurement devices for bicycles or handlebars have the following disadvantages:

1. In traditional crank power measurement systems, because the strain gauges are designed to fit on the inner side of the crank, the power measured is not in the true direction of the effective force applied by the user.

2. Due to the problem that the power measured by the aforementioned traditional crank power measurement systems is not in the true direction of the effective force applied by the user, it is necessary to additionally design shear force sensors to sense the torsional deformation of the top surface of the crank to assist in analyzing and calculating the correct effective power.

3. Due to the problem that the power measured by the aforementioned traditional crank power measurement systems is not in the true direction of the effective force applied by the user, it is necessary to additionally design strain gauges arranged in various orientations to assist in analyzing and calculating the correct effective power.

### SUMMARY OF THE INVENTION

The primary objective of the present invention is to provide a crank power measurement system for addressing the shortcomings of traditional crank power measurement systems and achieving accurate and effective measurement of user force's effective power, thereby meeting high-quality requirements, saving material costs, and better meeting environmental and green energy requirements. To this end, the inventors strive to achieve the aforementioned objectives and effects. The present invention provides a crank power measurement system for sensing a force applied to a crank that extends along a direction defined as a first axis. One end of the crank serves as a force-receiving shaft end and the other end serves as a mounting shaft end. It is characterized in that the crank is formed with a hollow area, and a hollow area top wall, a hollow area bottom wall corresponding to the hollow area top wall, and corresponding hollow area inner walls are formed in the hollow area; at least one first strain gauge is located on the hollow area top wall; and at least one second strain gauge is located on the hollow area bottom wall.

In the present invention, it further includes at least one third strain gauge located on the hollow area top wall; at least one fourth strain gauge located on the hollow area bottom wall; at least one first shear force sensor located on the hollow area top wall; and at least one second shear force sensor located on the hollow area bottom wall.

In the present invention, the force-receiving shaft end is coupled to a pedal or handlebar of a bicycle or exercise bike.

In the present invention, the attachment direction of the first strain gauge is oriented along the first axis towards the force-receiving shaft of the crank; the attachment direction of the at least one second strain gauge is oriented along the first axis towards the force-receiving shaft of the crank; the attachment direction of the third strain gauge is oriented at a 90-degree angle or a 45-degree angle relative to the attachment direction of the first strain gauge. The attachment direction of the at least one fourth strain gauge is oriented at a 90-degree angle or a 45-degree angle relative to the attachment direction of the at least one second strain gauge.

### BRIEF DESCRIPTION OF THE DRAWINGS

FIG. 1 shows a perspective view of a crank power measurement system according to the first embodiment of the present invention.

FIG. 2 shows a right side view of a crank power measurement system according to the first embodiment of the present invention.

FIG. 3 shows a front side view of a crank power measurement system according to the first embodiment of the present invention.

FIG. 4 shows a control circuit diagram according to the present invention.

FIG. 5 shows a perspective view of a crank power measurement system according to the second embodiment of the present invention.

FIG. 6 shows a right side view of a crank power measurement system according to the second embodiment of the present invention.

FIG. 7 shows a front side view of a crank power measurement system according to the second embodiment of the present invention.

FIG. 8 shows a perspective view of a crank power measurement system according to the third embodiment of the present invention.

FIG. 9 shows a right side view of a crank power measurement system according to the third embodiment of the present invention.

FIG. 10 shows a front side view of a crank power measurement system according to the third embodiment of the present invention.

FIG. 11 shows a perspective view of a crank power measurement system according to the fourth embodiment of the present invention.

FIG. 12 shows a right side view of a crank power measurement system according to the fourth embodiment of the present invention.

FIG. 13 shows a front side view of a crank power measurement system according to the fourth embodiment of the present invention.

FIG. 14 shows a perspective view of a crank power measurement system according to the fifth embodiment of the present invention.

FIG. 15 shows a right side view of a crank power measurement system according to the fifth embodiment of the present invention.

FIG. 16 shows a front side view of a crank power measurement system according to the fifth embodiment of the present invention.

FIG. 17 shows an operating state view of a crank power measurement system of the present invention interacting with a wireless charging battery.

FIG. 18 shows an exploded perspective schematic view of the crank power measurement system and the charging battery of FIG. 17.

### DETAILED DESCRIPTION OF THE PREFERRED EMBODIMENT

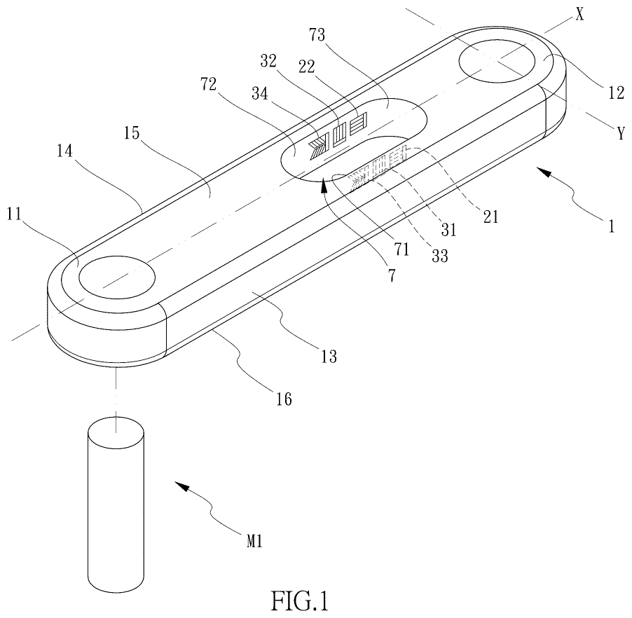

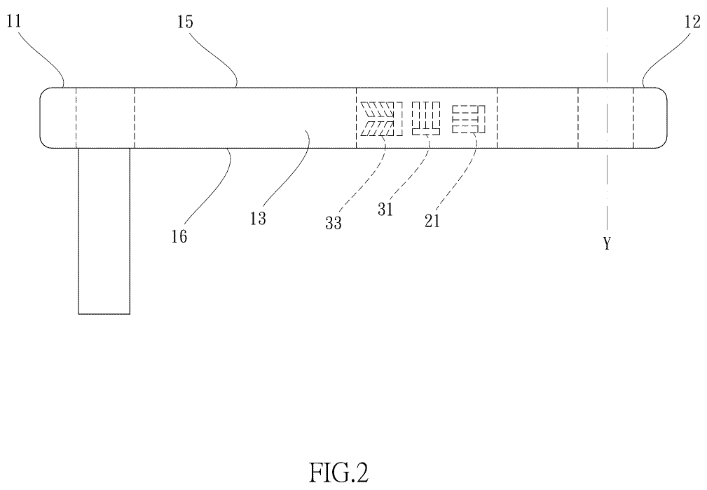

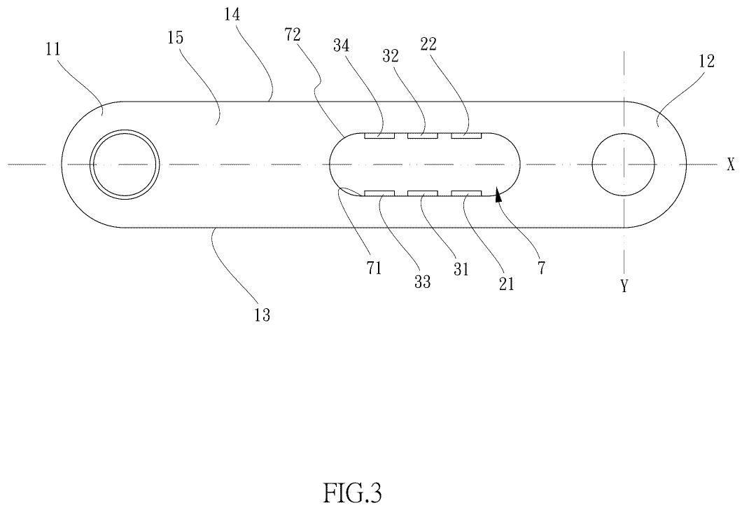

Refer to FIGS. 1 to 3, which show perspective, right side and front views, respectively, of a crank power measurement system according to the first embodiment of the present invention. As shown, a crank 1 extends along a direction defined as a first axis X, and the direction perpendicular to the first axis X is defined as a second axis Y.

One end of the crank 1 serves as a force-receiving shaft end 11, which can be coupled to the pedal of a bicycle (not shown) or the handlebar of an exercise bike (not shown), while the other end of the crank 1, opposite to the force-receiving shaft end 11, serves as a mounting shaft end 12, which can be mounted on a bracket of a bicycle or exercise bike (not shown).

Taking a bicycle as an example, when a user applies a force in a force direction M1 on the force-receiving shaft end 11, the crank 1 is forced to rotate around the mounting shaft end 12 as the center. At this time, the force will mainly be reflected on the top surface 13 and the bottom surface 14 of the crank 1. The force may also simultaneously cause torsional deformation of the top surface 13 and bottom surface 14. Additionally, the force may simultaneously cause torsional deformation of the inner surface 15 and outer surface 16 of the crank 1.

In this embodiment, a hollow area 7 is formed at approximately the middle position of the crank 1. In the hollow area 7, a hollow area top wall 71, a hollow area bottom wall 72 corresponding to the hollow area top wall 71, and a corresponding pair of inner walls 73 are formed.

At least one first strain gauge 21 is located on the hollow area top wall 71 with its attachment direction oriented along the first axis X towards the force-receiving shaft 11 of the crank 1. When a user applies a force in the force direction M1 on the force-receiving shaft end 11, the crank 1 rotates around the mounting shaft end 12 as the center. At this time, the first strain gauge 21 can sense the deformation of the hollow area top wall 71.

At least one second strain gauge 22 is located on the hollow area bottom wall 72 with its attachment direction oriented along the first axis X towards the force-receiving shaft 11 of the crank 1. When a user applies a force in the force direction M1 on the force-receiving shaft end 11, the crank 1 rotates around the mounting shaft end 12 as the center. At this time, the second strain gauge 22 can sense the deformation of the hollow area bottom wall 72.

At least one third strain gauge 31 is located on the hollow area top wall 71 adjacent to the first strain gauge 21 with its attachment direction oriented at a 90-degree angle relative to the first axis X. When a user applies a force in the force direction M1 on the force-receiving shaft end 11, the crank 1 rotates around the mounting shaft end 12 as the center. At this time, the third strain gauge 31 can sense the torsional deformation of the hollow area top wall 71.

At least one fourth strain gauge 32 is located on the hollow area bottom wall 72 adjacent to the third strain gauge 31 with its attachment direction oriented at a 90-degree angle relative to the first axis X. When a user applies a force in the force direction M1 on the force-receiving shaft end 11, the crank 1 rotates around the mounting shaft end 12 as the center. At this time, the fourth strain gauge 32 can sense the torsional deformation of the hollow area bottom wall 72.

The hollow area top wall 71 can be additionally equipped with a first shear force sensor 33, while the hollow area bottom wall 72 can be additionally equipped with a second shear force sensor 34. The first shear force sensor 33 is used to sense the torsional deformation of the hollow area top wall 71, and the second shear force sensor 34 can sense the torsional deformation of the hollow area bottom wall 72.

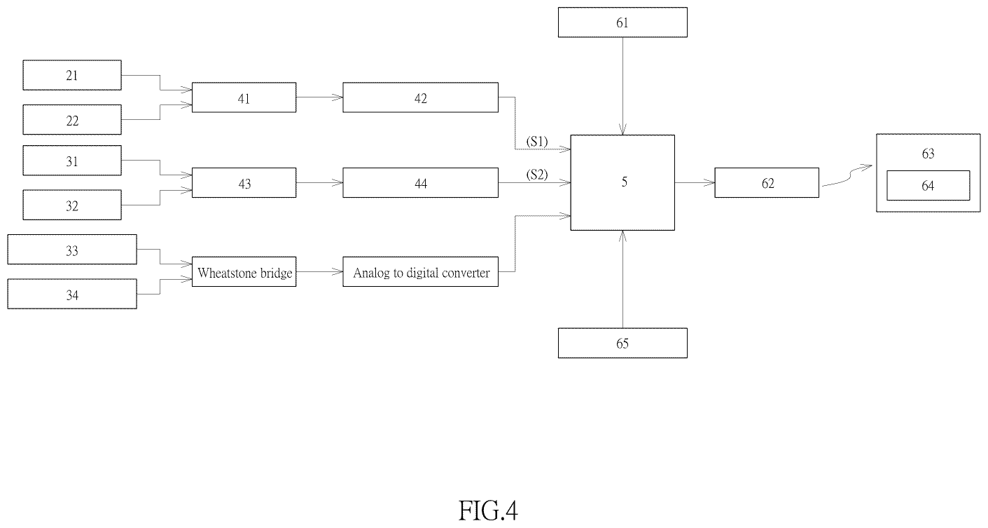

Refer to FIG. 4, which shows a control circuit diagram according to the present invention. The first strain gauge 21 and the second strain gauge 22, after being connected through a Wheatstone bridge 41 (configured either as a full bridge or a half bridge) and an analog-to-digital converter 42, generate a first stress signal S1 to a processing unit 5. Similarly, the third strain gauge 31 and the fourth strain gauge 32, after being connected through a Wheatstone bridge 43 and an analog-to-digital converter 44, generate a second stress signal S2 to the processing unit 5. The first shear force sensor 33 and the second shear force sensor 34 also are connected to the processing unit 5 through the known Wheatstone bridge (configured either as a full bridge or a half bridge) and the analog-to-digital converter.

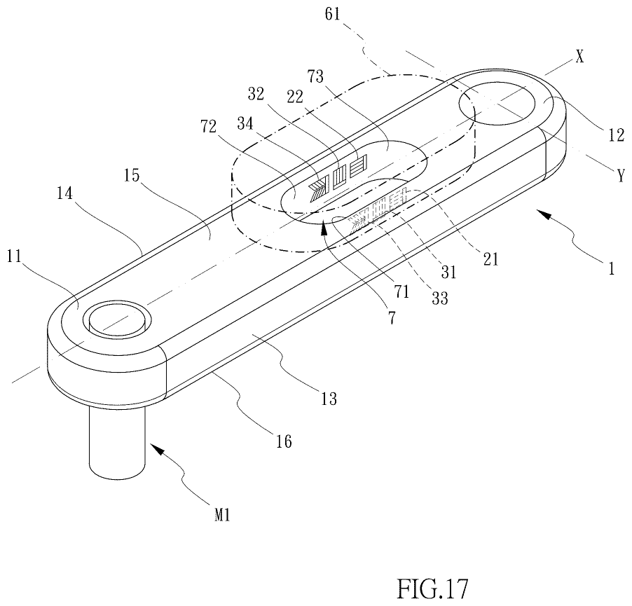

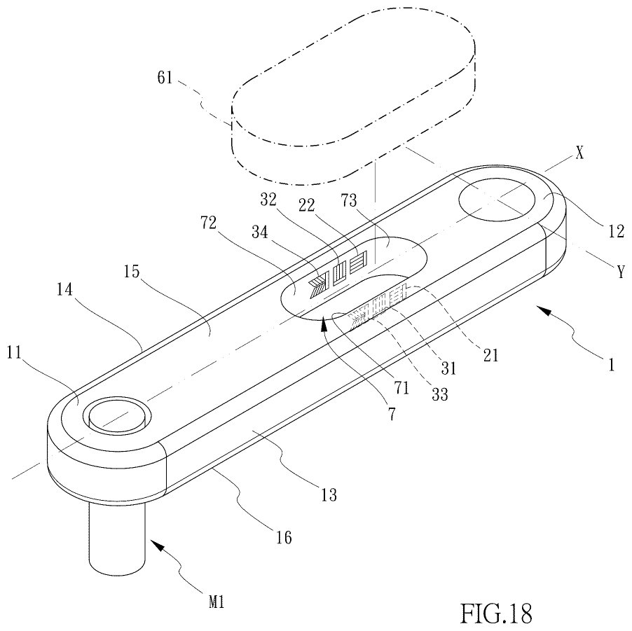

The power supply unit 61 (such as batteries, rechargeable batteries or wireless charging batteries) can supply operational power to the processing unit 5, various strain gauges 21, 22, 31, 32, and other circuit components. The aforementioned wireless charging battery may include various wireless power supply devices such as Bluetooth, infrared, RFID, etc., as shown in FIGS. 4, 17 and 18.

After receiving the first stress signal S1 and the second stress signal S2, the processing unit 5 can process and compute the signals. Subsequently, through a wireless transmitter 62, the processed signals are wirelessly transmitted (for example, using RF or Bluetooth) to a receiver 63, and displayed on a display 64 of the receiver 63. The receiver 63 can be a watch, smartphone, personal wearable device, network gateway, cloud, wireless network receiver or the like.

The control circuit of the present invention may also include other motion signal sensors 65. For example, the motion signal sensor 65 can be a gyroscope, a magnetometer, or an accelerometer with two or more axes, which can be used to sense other motion signals (such as sensing and calculating the angular velocity and rotation speed of the crank while it is being forced into motion), and send these motion signals to the processing unit 5.

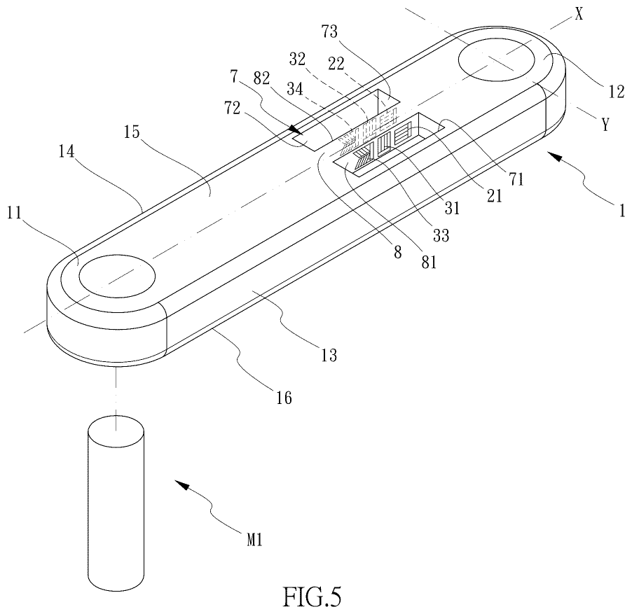

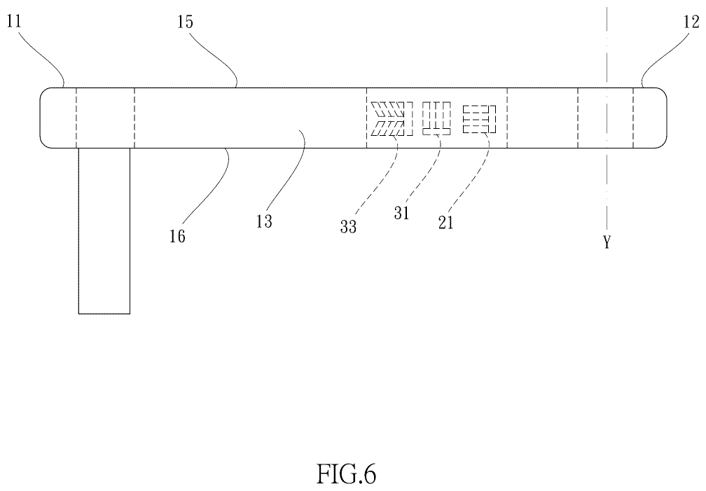

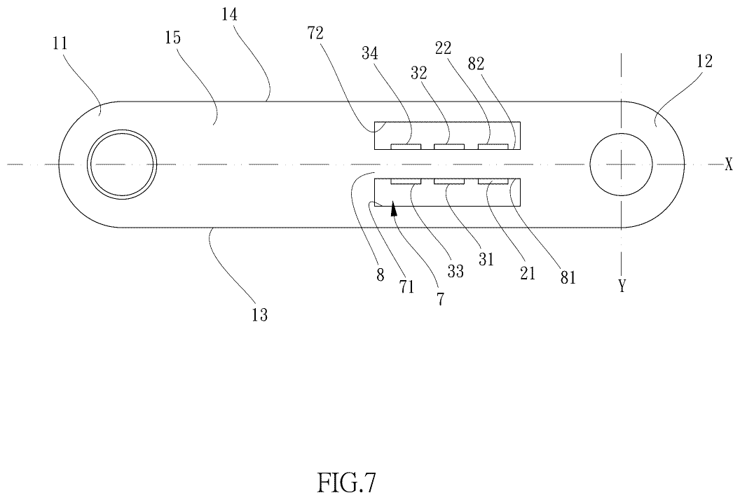

FIGS. 5, 6 and 7 show perspective, right side and front side views, respectively, of a crank power measurement system according to the second embodiment of the present invention. The components of this embodiment are generally similar to those of the first embodiment, so the same components are denoted by the same reference numbers.

In this embodiment, a hollow area 7 is formed at approximately the middle position of the crank 1, and a hollow area top wall 71, a hollow area bottom wall 72 corresponding to the hollow area top wall 71, and a corresponding pair of inner walls 73 are formed in the hollow area 7.

A cantilever 8 extends along its extending direction and is located between the inner walls 73 of the hollow area 7, forming a cantilever top surface 81 corresponding to the hollow area top wall 71 and a cantilever bottom surface 82 corresponding to the hollow area bottom wall 72. The cantilever 8 can be a fixed or removable cantilever unit.

At least one first strain gauge 21 is located on the cantilever top surface 81 with its attachment direction oriented along the first axis X towards the force-receiving shaft 11 of the crank 1. When a user applies a force in the force direction M1 on the force-receiving shaft end 11, the crank 1 rotates around the mounting shaft end 12 as the center. At this time, the first strain gauge 21 can sense the deformation of the cantilever top surface 81.

At least one second strain gauge 22 is located on the cantilever bottom surface 82 with its attachment direction oriented along the first axis X towards the force-receiving shaft 11 of the crank 1. When a user applies a force in the force direction M1 on the force-receiving shaft end 11, the crank 1 rotates around the mounting shaft end 12 as the center. At this time, the second strain gauge 22 can sense the deformation of the cantilever bottom surface 82.

At least one third strain gauge 31 is located on the cantilever top surface 81 adjacent to the at least one first strain gauge 21 with its attachment direction oriented at a 90-degree angle relative to the first axis X. When a user applies a force in the force direction M1 on the force-receiving shaft end 11, the crank 1 rotates around the mounting shaft end 12 as the center. At this time, the third strain gauge 31 can sense the torsional deformation of the cantilever top surface 81.

At least one fourth strain gauge 32 is located on the cantilever bottom surface 82 adjacent to the at least one third strain gauge with its attachment direction oriented at a 90-degree angle relative to the first axis X. When a user applies a force in the force direction M1 on the force-receiving shaft end 11, the crank 1 rotates around the mounting shaft end 12 as the center. At this time, the fourth strain gauge 32 can sense the torsional deformation of the cantilever bottom surface 82.

The cantilever top surface 81 can be equipped with a first shear force sensor 33, while the cantilever bottom surface 82 can be additionally equipped with a second shear force sensor 34. The first shear force sensor 33 is used to sense the torsional deformation of the cantilever top surface 81, and the second shear force sensor 34 can sense the torsional deformation of the cantilever bottom surface 82.

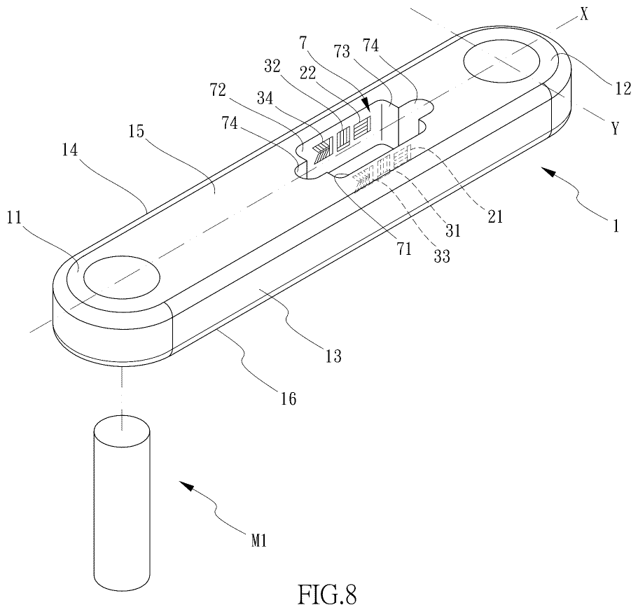

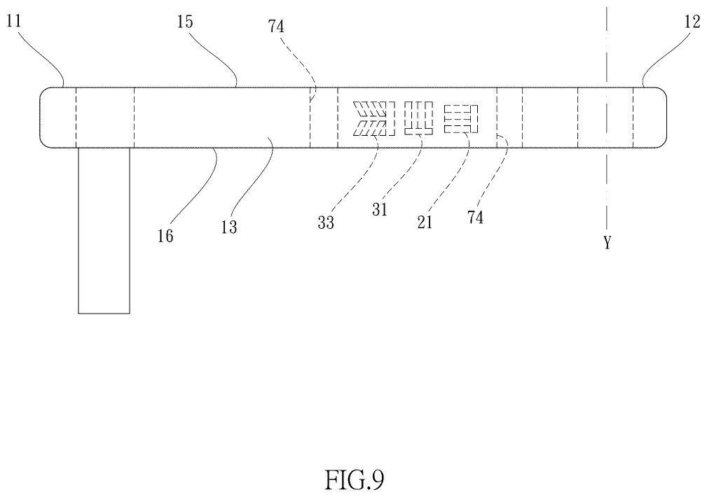

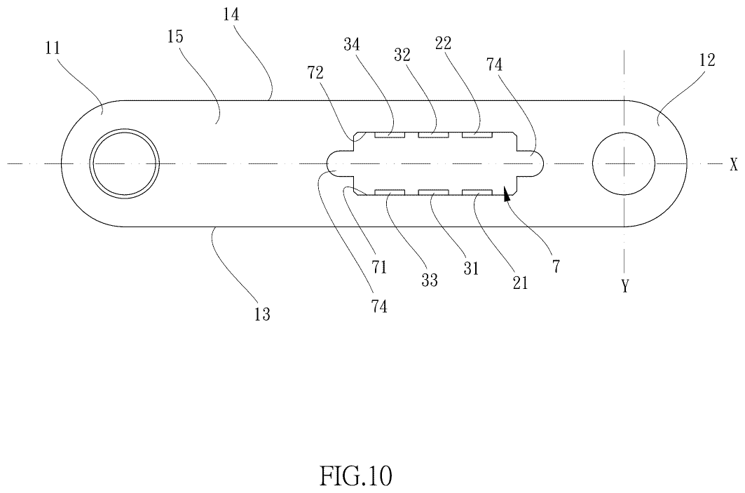

FIGS. 8, 9 and 10 show perspective, right side and front side views, respectively, of a crank power measurement system according to the third embodiment of the present invention. The components of this embodiment are generally similar to those of the first embodiment, except that a hollow area 7 is formed at approximately the middle position of the crank 1 and has a hollow area bottom wall 72 corresponding to a hollow area top wall 71 and a corresponding pair of inner walls 73 formed therein. Additionally, a recess 74 is formed in the hollow area 7 towards the force-receiving shaft end 11, and a corresponding recess 74 is formed towards the mounting shaft end 12.

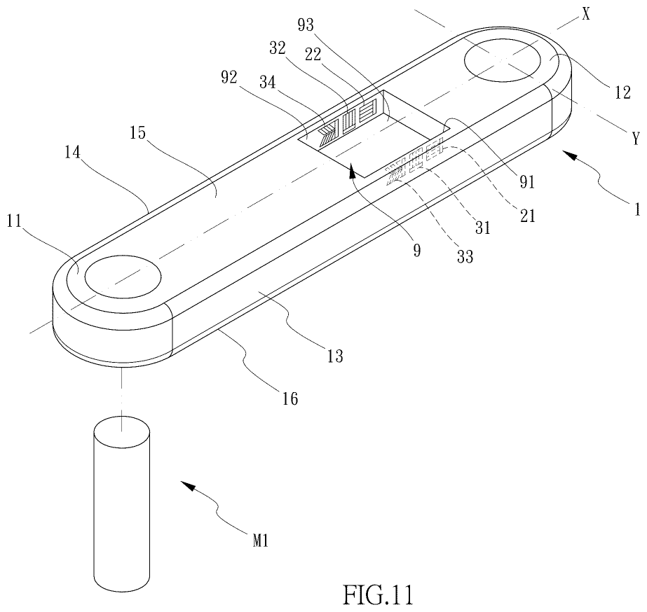

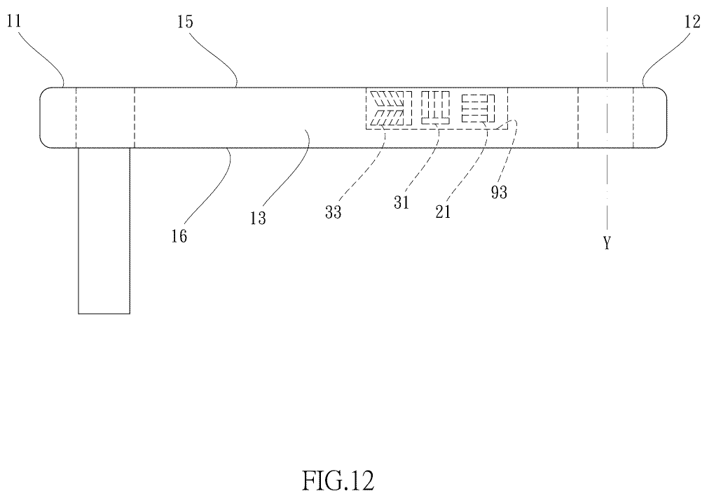

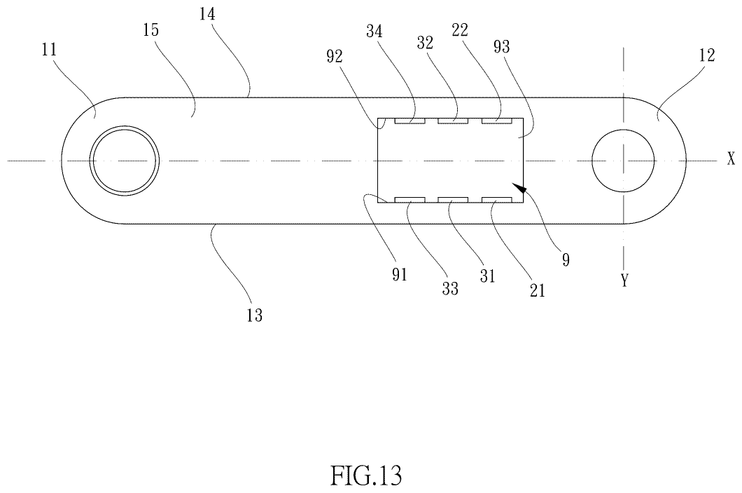

FIGS. 11, 12 and 13 show perspective, right side and front side views, respectively, of a crank power measurement system according to the fourth embodiment of the present invention. The components of this embodiment are generally similar to those of the first embodiment, so the same components are denoted by the same reference numbers.

In this embodiment, the inner surface 15 (which can also be the outer surface) of the crank 1 is formed with a recessed space 9, which can accommodate various circuit components (such as batteries, circuit boards). The recessed space 9 can be covered with a cover plate to achieve waterproofing.

The first strain gauge 21 in this embodiment is positioned in the recessed space 9 corresponding to a recessed space top wall 91 at the top surface 13 of the crank 1 with its attachment direction oriented along the first axis X towards the force-receiving axis 11 of the crank 1. When a user applies a force in the force direction M1 on the force-receiving shaft end 11, the crank 1 rotates around the mounting shaft end 12 as the center. At this time, the first strain gauge 21 can sense the deformation of the recessed space top wall 91 of the crank 1. The deformation of the recessed space top wall 91 is substantially equal to the deformation of the top surface 13 of the crank 1.

The second strain gauge 22 is positioned in the recessed space 9 corresponding to a recessed space bottom wall 92 at the bottom surface 14 of the crank 1 with its attachment direction oriented along the first axis X towards the force-receiving axis 11 of the crank 1. When a user applies a force in the force direction M1 on the force-receiving shaft end 11, the crank 1 rotates round the mounting shaft end 12 as the center. At this time, the second strain gauge 22 can sense the deformation of the recessed space bottom wall 92 of the crank 1. The deformation of the recessed space bottom wall 92 is substantially equal to the deformation of the bottom surface 14 of the crank 1.

The third strain gauge 31 is positioned in the recessed space 9 corresponding to the recessed space top wall 91 at the top surface 13 of the crank 1 with its attachment direction oriented at a 90-degree angle (or 45-degree angle) relative to the first axis X. When a user applies a force in the force direction M1 on the force-receiving shaft end 11, the crank 1 rotates around the mounting shaft end 12 as the center. At this time, the third strain gauge 31 can sense the torsional deformation of the recessed space top wall 91 of the crank 1.

At least one fourth strain gauge 32 is positioned in the recessed space 9 corresponding to a recessed space bottom wall 92 at the bottom surface 14 of the crank 1 with its attachment direction oriented at a 90-degree angle (or 45-degree angle) relative to the first axis X. When a user applies a force in the force direction M1 on the force-receiving shaft end 11, the crank 1 rotates around the mounting shaft end 12 as the center. At this time, the fourth strain gauge 32 can sense the torsional deformation of the recessed space bottom wall 92 of the crank 1.

The recessed space top wall 91 or the recessed space inner wall 93 can be equipped with a first shear force sensor 33 as illustrated in the previous embodiments, while the recessed space bottom wall 92 or the recessed space inner wall 93 can be equipped with a second shear force sensor 34 as illustrated in the previous embodiments, to sense the torsional deformation of the crank 1.

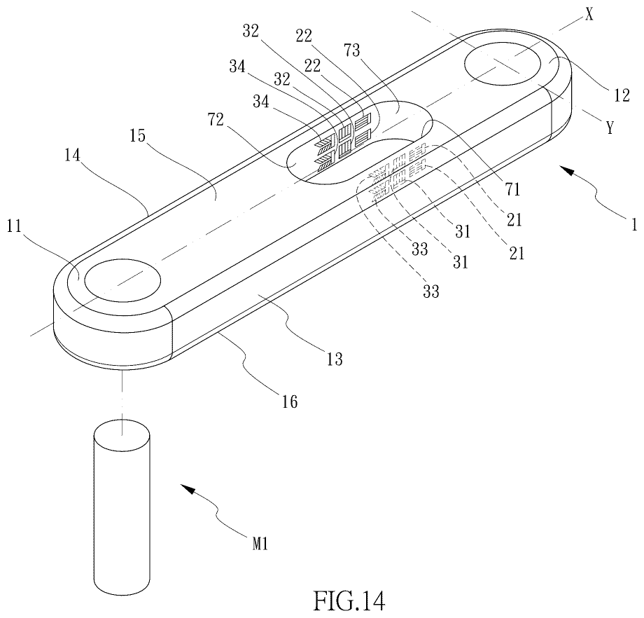

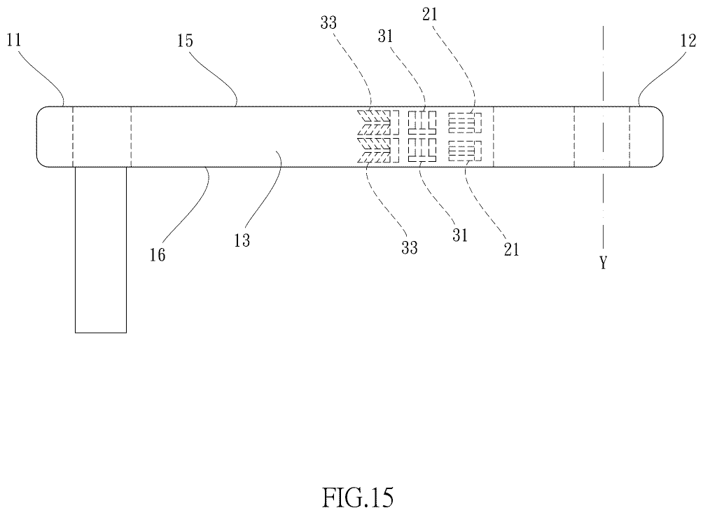

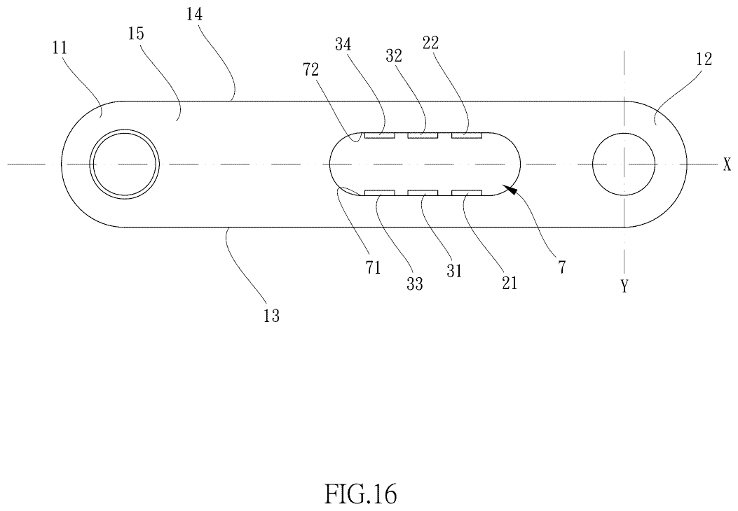

FIGS. 14, 15 and 16 show perspective, right side and front side views, respectively, of a crank power measurement system according to the fifth embodiment of the present invention. The components of this embodiment are generally similar to those of the first embodiment, so the same components are denoted by the same reference numbers. In the fifth embodiment, multiple sets of first strain gauges 21, second strain gauges 22, third strain gauges 31, the fourth strain gauges 32, first shear force sensors 33, and second shear force sensors 34 are arranged on the recessed space top wall 71 and the recessed space bottom wall 72 at both sides of the recessed area 7. In the figure, two sets of first strain gauges 21, second strain gauges 22, third strain gauges 31, the fourth strain gauges 32, first shear force sensors 33 and second shear force sensors 34 are illustrated on the recessed space top wall 71 and the recessed space bottom wall 72.

What is claimed is:

1. A crank power measurement system for sensing a force applied to a crank that extends along a direction defined as a first axis and has one end as a force-receiving shaft end and the other end as a mounting shaft end, wherein the crank power measurement system is characterized in that:
the crank is formed with a hollow area, and a hollow area top wall, a hollow area bottom wall corresponding to the hollow area top wall, and corresponding hollow area inner walls are formed in the hollow area;
at least one first strain gauge is located on the hollow area top wall; and
at least one second strain gauge is located on the hollow area bottom wall.

2. The crank power measurement system as claimed in claim 1, further comprises:
at least one third strain gauge located on the hollow area top wall;
at least one fourth strain gauge located on the hollow area bottom wall;
at least one first shear force sensor located on the hollow area top wall; and
at least one second shear force sensor located on the hollow area bottom wall.

3. The crank power measurement system as claimed in claim 1, further comprising:
a Wheatstone bridge;
an analog to digital converter;
a processing unit; and
a power supply unit;
wherein the at least one first strain gauge and the at least one second strain gauge are electrically connected to the processing unit through the Wheatstone bridge and the analog to digital converter, and the power supply unit is detachably and electrically connected to the processing unit, providing electrical power to the processing unit and all the strain gauges.

4. The crank power measurement system as claimed in claim 2, further comprising:
a Wheatstone bridge;
an analog to digital converter;
a processing unit; and
a power supply unit;
wherein the at least one third strain gauge and the at least one fourth strain gauge are electrically connected to the processing unit through the Wheatstone bridge and the analog to digital converter, and the power supply unit is detachably and electrically connected to the processing unit, providing electrical power to the processing unit and all the strain gauges.

5. The crank power measurement system as claimed in claim 3, wherein the power supply unit is a battery, a rechargeable battery or a wireless charging battery.

6. The crank power measurement system as claimed in claim 4, wherein the power supply unit is a battery, a rechargeable battery or a wireless charging battery.

7. A crank power measurement system for sensing a force applied to a crank that extends along a direction defined as a first axis and has one end as a force-receiving shaft end and the other end as a mounting shaft end, wherein the crank power measurement system is characterized in that:
the crank is formed with a hollow area, and a hollow area top wall, a hollow area bottom wall corresponding to the hollow area top wall, and corresponding hollow area inner walls are formed in the hollow area;
a cantilever extends along an extending direction and is located between the inner walls of the hollow area, forming a cantilever top surface corresponding to the hollow area top wall and a cantilever bottom surface corresponding to the hollow area bottom wall;
at least one first strain gauge is located on the cantilever top surface; and
at least one second strain gauge is located on the cantilever bottom surface.

8. The crank power measurement system as claimed in claim 7, further comprises:
at least one third strain gauge located on the cantilever top surface;
at least one fourth strain gauge located on the cantilever bottom surface;
at least one first shear force sensor located on the cantilever top surface; and
at least one second shear force sensor located on the cantilever bottom surface.

9. The crank power measurement system as claimed in claim 7, further comprises:
a Wheatstone bridge;
an analog to digital converter;
a processing unit; and
a power supply unit;
wherein the at least one first strain gauge and the at least one second strain gauge are electrically connected to the processing unit through the Wheatstone bridge and the analog to digital converter, and the power supply unit is detachably and electrically connected to the processing unit, providing electrical power to the processing unit and all the strain gauges.

10. The crank power measurement system as claimed in claim 8, further comprises:
a Wheatstone bridge;
an analog to digital converter;
a processing unit; and
a power supply unit;
wherein the at least one third strain gauge and the at least one fourth strain gauge are electrically connected to the processing unit through the Wheatstone bridge and the analog to digital converter, and the power supply unit is detachably and electrically connected to the processing unit, providing electrical power to the processing unit and all the strain gauges.

11. The crank power measurement system as claimed in claim 9, wherein the power supply unit is a battery, a rechargeable battery or a wireless charging battery.

12. The crank power measurement system as claimed in claim 10, wherein the power supply unit is a battery, a rechargeable battery or a wireless charging battery.

13. A crank power measurement system for sensing a force applied to a crank that extends along a direction defined as a first axis and has one end as a force-receiving shaft end and the other end as a mounting shaft end, wherein the crank power measurement system is characterized in that:
a recessed space is formed at one side surface of the crank, and a recessed space top wall, a recessed space bottom wall corresponding to the recessed space top wall, and corresponding recessed space inner walls are formed in the recessed space;
at least one first strain gauge is located on the recessed space top wall; and
at least one second strain gauge is located on the recessed space bottom wall.

14. The crank power measurement system as claimed in claim 13, further comprises:
at least one third strain gauge located on the recessed space top wall;
at least one fourth strain gauge located on the recessed space bottom wall;
at least one first shear force sensor located on the recessed space top wall; and
at least one second shear force sensor located on the recessed space bottom wall.

15. The crank power measurement system as claimed in claim 13, further comprising:
a Wheatstone bridge;
an analog to digital converter;
a processing unit; and
a power supply unit;
wherein the at least one first strain gauge and the at least one second strain gauge are electrically connected to the processing unit through the Wheatstone bridge and the analog to digital converter, and the power supply unit is detachably and electrically connected to the processing unit, providing electrical power to the processing unit and all the strain gauges.

16. The crank power measurement system as claimed in claim 14, further comprising:
a Wheatstone bridge;
an analog to digital converter;
a processing unit; and
a power supply unit;
wherein the at least one third strain gauge and the at least one fourth strain gauge are electrically connected to the processing unit through the Wheatstone bridge and the analog to digital converter, and the power supply unit is detachably and electrically connected to the processing unit, providing electrical power to the processing unit and all the strain gauges.

17. The crank power measurement system as claimed in claim 15, wherein the power supply unit is a battery, a rechargeable battery or a wireless charging battery.

18. The crank power measurement system as claimed in claim 16, wherein the power supply unit is a battery, a rechargeable battery or a wireless charging battery.

19. The crank power measurement system as claimed in claim 1, wherein the force-receiving shaft end is coupled to a pedal or handlebar of a bicycle or exercise bike.

20. The crank power measurement system as claimed in claim 2, wherein:
an attachment direction of the at least one first strain gauge is oriented along the first axis towards the force-receiving shaft of the crank;
an attachment direction of the at least one second strain gauge is oriented along the first axis towards the force-receiving shaft of the crank;
an attachment direction of the at least one third strain gauge is oriented at a 90-degree angle or a 45-degree angle relative to the attachment direction of the at least one first strain gauge; and
an attachment direction of the at least one fourth strain gauge is oriented at a 90-degree angle or a 45-degree angle relative to the attachment direction of the at least one second strain gauge.
